(19) United States
(12) Patent Application Publication
(10) Pub. No.: US 2003/0044250 A1
(43) Pub. Date: Mar. 6, 2003

(54) Production jigs for slatted three platform convertible futon bed

(76) Inventor: Thomas C. Inskip, Gualan (GT)

Correspondence Address: Thomas C. Inskip, Barrio La Cienaga, Gualan, GT

(21) Appl. No.: 09/940,012

(22) Filed: Aug. 28, 2001

(51) Int. Cl. B23B 51/00

(52) U.S. Cl. 408/233

(57) ABSTRACT

Design improvements and production jig tools make robust slatted three platform Futon Bed that converts from Bed (2) to Chair (1) or couch. Drill jigs locate holes in each panel. Other jigs form the platform matrixes. Jigs cooperate and assure production with a DRILL GUIDE. The platforms are glued. Improved glue prevents side force from deforming platforms. Design and jigs support fabrication in developing nations. Bed (2) disassembles into four smaller transportable components (3,4,5,6) by the removal of pins. Upper_Foot (13), Upper_Side (12) and Bottom (14) form a storage compartment and reinforce Upper_Pedestal (5) structure. Latch (17) cooperates with Upper_Foot (13) to latch the Chair (1) configuration and prohibit the Chair (1) from decomposing. Additionally, Latch_Catch (36) in Upper_Foot (13) serves as a clearance slot for hinges in the Bed (2) configuration. Platforms are fully symmetrical. In the event of damage to a hinge location, platform hinge reversal restores the convertible bed.

### REFERENCE TO MICROFICHE APPENDIX

Not Applicable

### BACKGROUND OF INVENTION

The relative movement of sections converts this bed to a chair, couch, or seat. (See: US CL 5/12.1) The bed has a storage compartment, may be knocked-down for storage or transportation, and width may reduce to a single bed.

The present invention relates generally to multi-function furniture, and jig tools.

Multi-function furniture became known years ago. Often these required special industrial systems that manufactured them. As greater numbers of persons occupied the cities, living space decreased. As available materials decreased, value of furniture increased. As employment often demands relocation, break-down furniture gained utility. Unfortunately, break-down furniture proved delicate, breakable, and required specialized parts for reconstruction. Lost, or damaged parts made such furniture impractical.

Above cross referenced related applications present folding beds, but no production jigs.

### BRIEF SUMMARY OF INVENTION

This convertible bed-chair is proven prior art. Engineered jigs and improvements make this design produceable, marketable, price-worthy, secure, plain, maintainable, repairable, and robust. In a boxed shipping configuration, 200 units load into a sea-container.

This convertible bed design meets 21st Century needs of administrators, managers, and household utility. This convertible bed both converts to chair and breaks-down for storage or transport. Each platform holds two complete sets of hinge fixture holes. By reversal of the platform, damaged platforms return to service. If other parts break, they provide an example template for the production of a duplicate part. In this method, broken parts easily reproduce. Other materials are common industrial metric productions.

Industrial production jigs and dies of the 20th Century still make the best business practice for mass production. Labor time for the production of one convertible bed is ten to twenty times as great as aggressive industrial production with computer controlled machines. Industrial production with highly skilled labor using computer controlled machine is five times as expensive as jig production. In addition, good industrial production jigs permit small production runs without great start-up cost. International transportation of industrial production jigs to another location seldom brings taxation. Production may follow material supply and labor availability.

A futon type mattress serves two purposes with this convertible bed chair configuration. This convertible chair becomes a couch with the addition of a mattress draped over the back and folded double upon the seat. When a bed, the same mattress serves as bedding foundation.

Here in after DRILL GUIDE shall refer to U.S. Pat. No. 3,874,810 (or equivalent) and “(DG10)” or “(DG12)” shall reference part 10 or 12 respectively in DRILL GUIDE.

Jigs provide enlarged plate surfaces or leg locator holes for cooperation with DRILL GUIDE legs (DG12) or base plate (DG10).

### BRIEF DESCRIPTION OF THE SEVERAL VIEWS OF THE DRAWINGS

FIG. 1: A perspective view of Chair (1) and Bed (2),

FIG. 2: An exploded view of the Bed (2).

FIG. 3: A perspective view of Upper_Platform (3).

FIG. 4: A perspective view of the Center_Platform (4).

FIG. 5: A perspective view of the Upper_Pedestal (5).

FIG. 6: A perspective view of the Lower_Section (6).

FIG. 7: A top view of the Bed (2).

FIG. 8: A side view of the Bed (2).

FIG. 9: A perspective view of the Lower_Foot (9), Top_Lower_Foot_Jig (47), and Front_Lower_Foot_Jig (48).

FIG. 10: A perspective view of the Upper_Rail (10) and Upper_Rail_Jig (49).

FIG. 11: A perspective view of the Lower_Rail (11) and Lower_Rail_Jig (51).

FIG. 12: A perspective view of the Upper_Side (12), End_Upper_Side_Jig (22), and Front_Upper_Side_Jig (52).

FIG. 13: A perspective view of Upper_Foot (13) and Upper_Foot_Jig (57).

FIG. 14: A perspective view of the Bottom (14), End_Bottom_Jig (53), and Front_Bottom_Jig (54).

FIG. 15: A perspective view of the Slat (15) and Slat_Jig (55).

FIG. 16: A perspective view of the Center_Rail (16) and Rail_Jig (19).

FIG. 17: A perspective view of the Latch (17) and Latch_Jig (20).

FIG. 18: A perspective view of the Lower_Side (18) and Lower_Side_Jig (21).

FIG. 19: A side view of the Rail_Jig (19).

FIG. 20: A side view of the Latch_Jig (20).

FIG. 21: A side view of the Lower_Side_Jig (21).

FIG. 22: A side view of the End_Upper_Side_Jig (22).

FIG. 23: A perspective view of the Positioner_Jig (23).

FIG. 24: A side view of the Clamp_Rod (24).

FIG. 25: A perspective view of the Shackle (25) and Shackle_Jig (61).

FIG. 26: A perspective view of a Racked_Platform (26).

FIG. 27: A perspective view of a Platform_Jig (27).

FIG. 28: A perspective view of a Clamp (28).

FIG. 29: A top view of the Clamp_Jig (29).

FIG. 30: A top view of the Clamp_Base 30).

FIG. 31: A perspective view of the exploded Platform_Jig (27) system.

FIG. 32: A perspective view of a Racked_Platform (26) and Platform_Jig (27).

FIG. 33: A magnified perspective view of a Racked_Platform (26) and Platform_Jig (27).

FIG. 34: A magnified perspective view of a corner of the Upper_Platform (3).

### DETAILED DESCRIPTION OF THE INVENTION

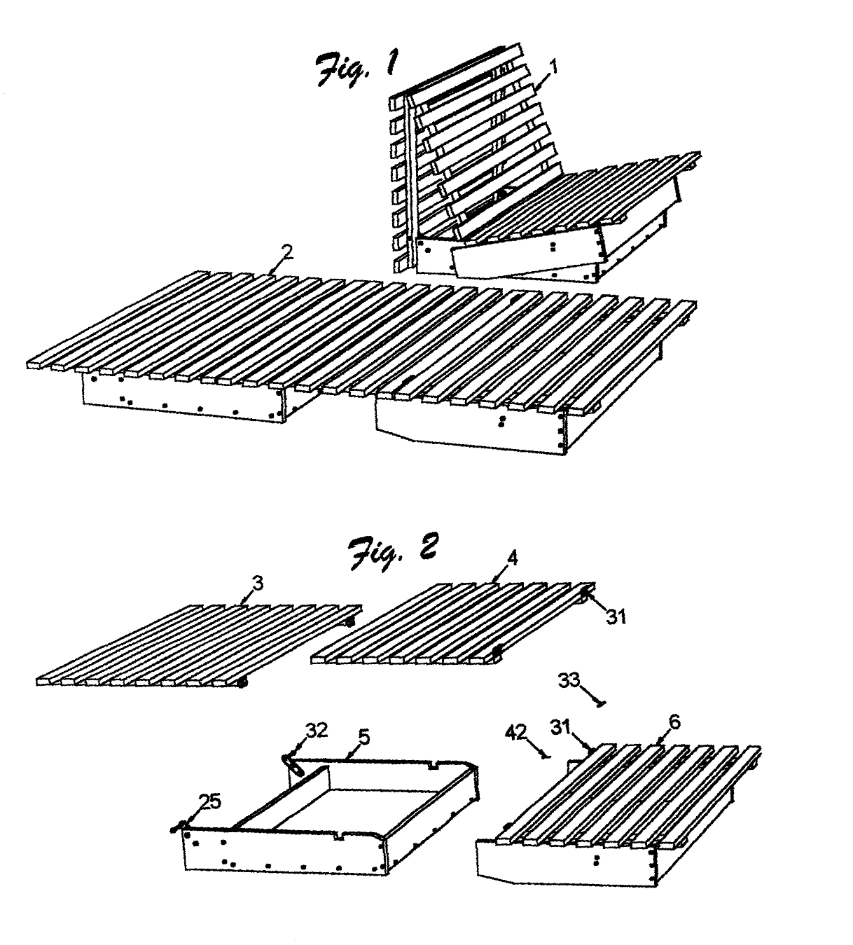

FIG. 1 is a perspective view of Chair (1) and Bed (2) that shows the working function of this configuration. This convertible Chair (1) becomes a couch with the addition of a mattress draped over the Upper_Platform (3) and folded double upon the Lower_Section (6). When a Bed (2), the same mattress serves as bedding foundation.

FIG. 2 is an exploded view of the Bed (2) that shows the four large components: Upper_Platform (3), Center_Platform (4), Upper_Pedestal (5), and Lower_Section (6). These four components (3,4,5,6) cooperate by means of hinges and shackles. The Lower_Section (6) provides two Hinge_Plates (31) that cooperates with the Hinge_Plates (31) attached to the Center_Platform (4). The Upper_Pedestal (5) provides two Shackles (25) that receive a Shackle_Pin (32) and cooperates with Upper_Platform (3). The Bed (2) breaks into four smaller parts for transport. All Hinge_Pins (33) and Shackle_Pins (32) are removable. All Hinge_Plates (31) provide Hinge_Fasteners (42). The Upper_Platform (3) provides Pin_Holes (34) (see: FIG. 34) to cooperate with the Shackle_Pin (32).

FIG. 3 is a perspective view of Upper_Platform (3) showing sub-components and features. The Upper_Platform (3) provides Upper_Rails (10) fixed to Slats (15) to form a flat matrix. The lower end of the Upper_Rails (10) receive Hinge_Plates (31). Each Upper_Rail (10) provides two Pin_Holes (34) (see: FIG. 34) to cooperate with Shackle_Pins (32) (see: FIG. 5). In the event of damage to an end Slat (15) or Pin_Hole (34) (see: FIG. 34), the Upper_Platform (3) provides for sub-component reversal to re-initiate service.

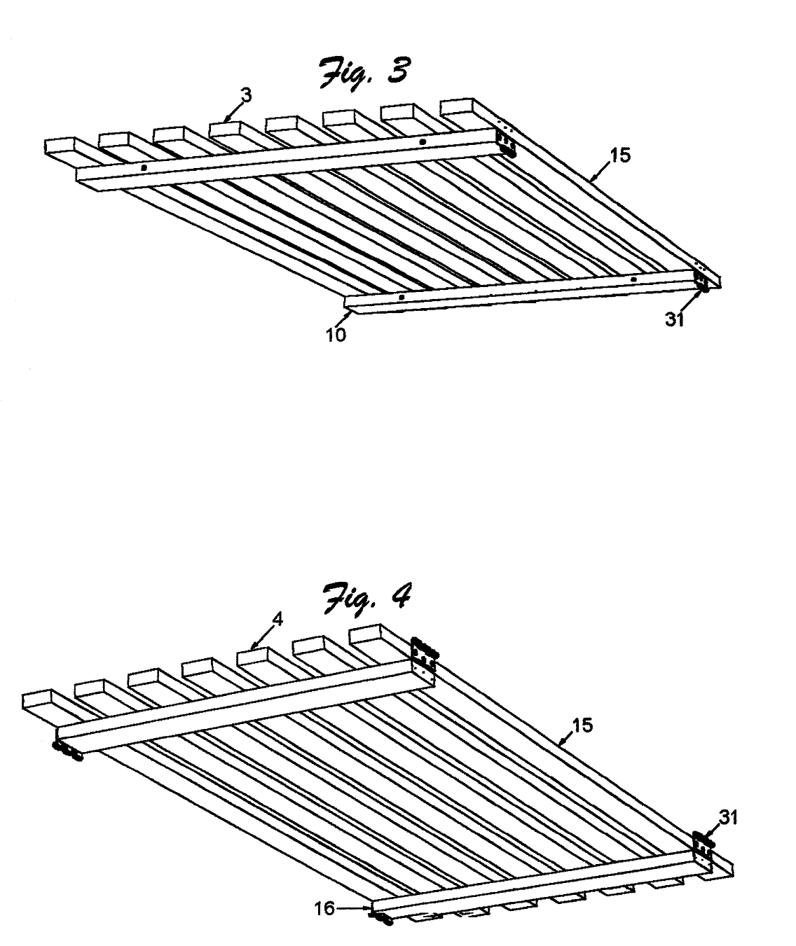

FIG. 4 is a perspective view of the Center_Platform (4) showing sub-components and features. The Center_Platform (4) provides Center_Rails (16) fixed to Slats (15) to form a flat matrix. Both ends of the Center_Rails (16) receive Hinge_Plates (31). In the event of damage to a Center_Rail (16) or Slat (15), the Center_Platform (4) provides for sub-component reversal to re-initiate service.

FIG. 5 is a perspective view of the Upper_Pedestal (5) showing sub-components and features. The Upper_Pedestal (5) provides two Upper_Foot (13), Upper_Side (12), Shackle (25), and Shackle_Pin (32), and one Bottom (14). The Bottom (14) receives Bottom_Fasteners (38) from the Upper_Foot (13) and Upper_Side (12). The Upper_Side (12) receives Upper_Side_Fasteners (37) from the Upper_Foot (13). The Shackle (25) receives Shackle_Fasteners (39) from the Upper_Foot (13). The Shackle (25) receives the Shackle_Pins (32). The lower part of the Upper_Foot (13) provides the Upper_Bevel (35) that permits easier conversion from Bed (2) (see: FIG. 1) to Chair (1) (see: FIG. 1). The top of the Upper_Foot (13) provides a Latch_Catch (36). Additionally, the Latch_Catch (36) provides a Hinge_Plate (31) (see: FIG. 3) clearance slot.

FIG. 6 is a perspective view of the Lowe_Section (6) showing sub-components and features. The Lower_Section (6) provides: Lower_Foot (9), Lower_Rail (11), Latch (17), Slats (15), and Hinge_Plates (31) (see: FIG. 4). The Lower_Rails (11) fix to the Slats (15) to form a Lower_Platform (44). The Latch (17) receives Latch_Fasteners (40) from the Lower_Foot (9). The Lower_Side (18) receives Lower_Side_Fasteners (41) from the Lower_Foot (9). The cooperative Hinge_Plates (31) (see: FIG. 4) for the Lower_Section (6) reside behind the last Slat (15). The Lower_Bevel (46) provides floor clearance to the Lower_Foot (9) in the Chair (1) (see: FIG. 1) configuration.

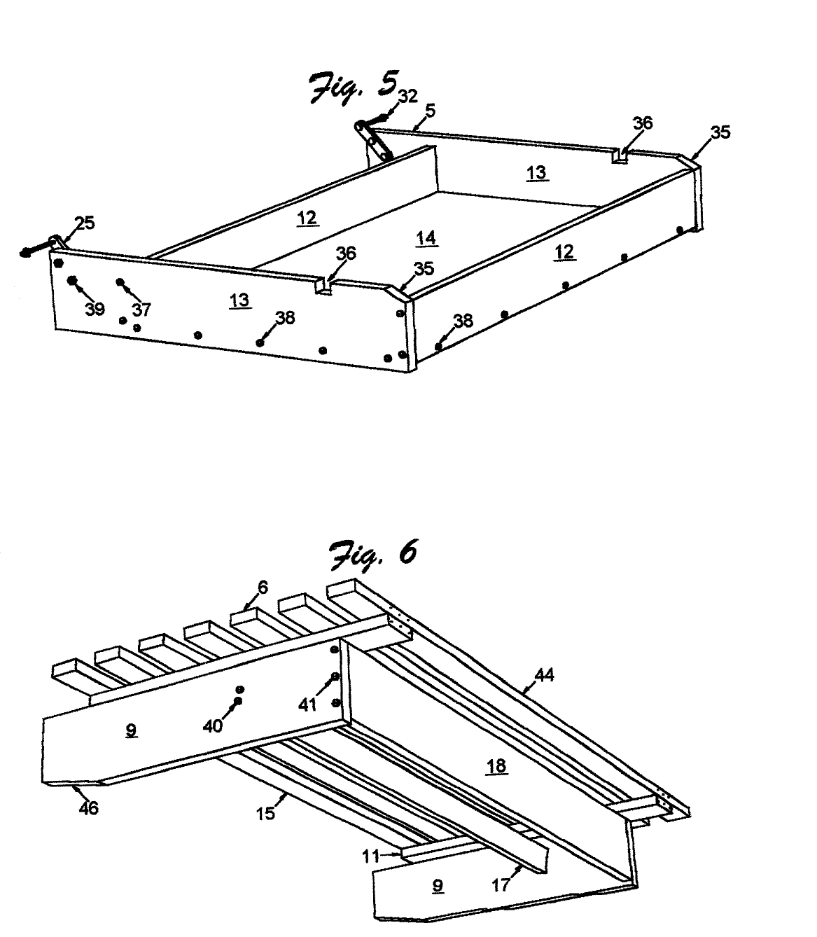

FIG. 7 is a top view of the Bed (2) showing organization. The Lower_Foot (9) (see: FIG. 6) receives Lower_Foot_Fasteners (7) from the Lower_Rail (11) (see: FIG. 6). In the event of damage to the Lower_Rail (11) (see: FIG. 6) or Slats (15) (see: FIG. 6), the Lower_Rail (11) (see: FIG. 6) provides an Obverse_Hole (8) that permits sub-component reversal of the Lower_Platform (44) for the re-initiation of service.

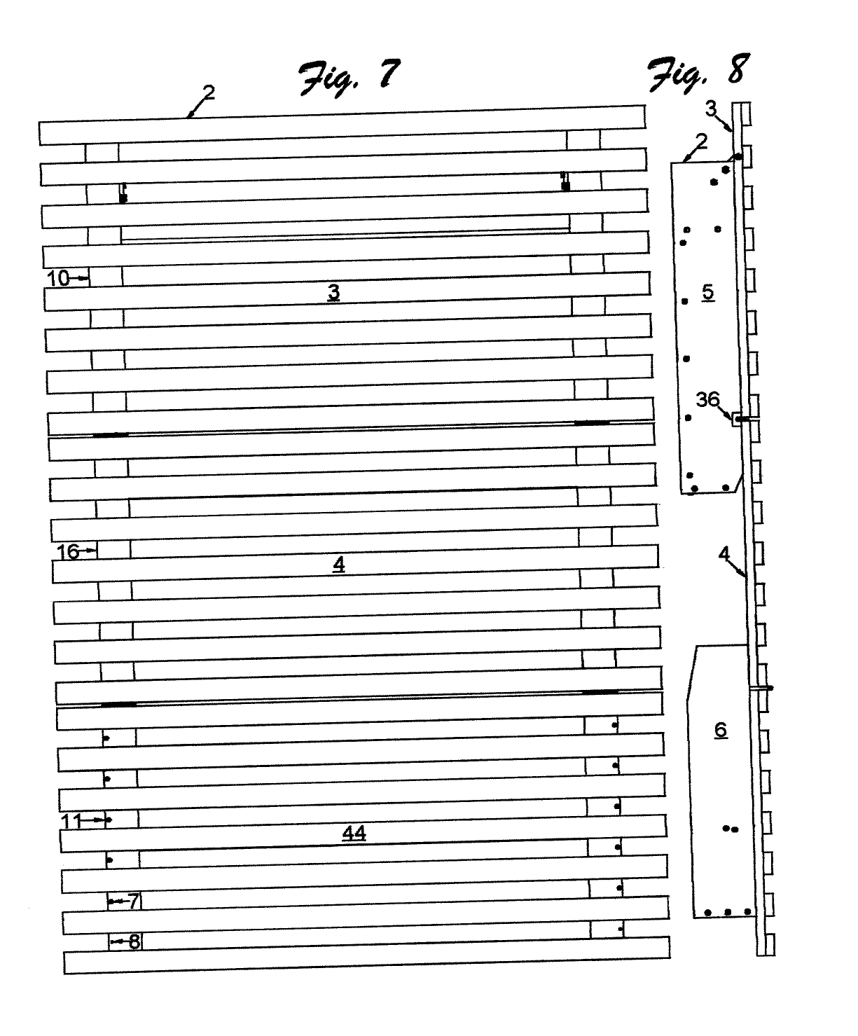

FIG. 8 is a side view of the Bed (2) showing organization. The Latch_Catch (36) provides clearance for Hinge_Plates (31) (see: FIGS. 3,4) that connect the Upper_Platform (3) and Center_Platform (4).

All jigs provide Locator_Rods (50) (see: FIG. 9) that position work to be drilled within the jig.

FIG. 9 is a perspective view of the Lower_Foot (9) showing organization, Top_Lower_Foot_Jig (47), and Front_Lower_Foot_Jig (48). The Top_Lower_Foot_Jig (47) provides Locator_Rods (50), and Drill_Bushings (45) for pilot holes that receive Lower_Foot_Fasteners (7) (see: FIG. 7) from the Lower_Rail (11) (see: FIG. 6). The Front_Lower_Foot_Jig (48) provides Locator_Rods (50), and Drill_Bushings (45) for clearance holes for the Lower_Side_Fasteners (41) (see: FIG. 6) and Latch_Fasteners (40) (see: FIG. 6). In addition, the Front_Lower_Foot_Jig (48) provides Drill_Bushings (45) for clearance holes that mark position and angle of the Lower_Bevel (46) (see: FIG. 6).

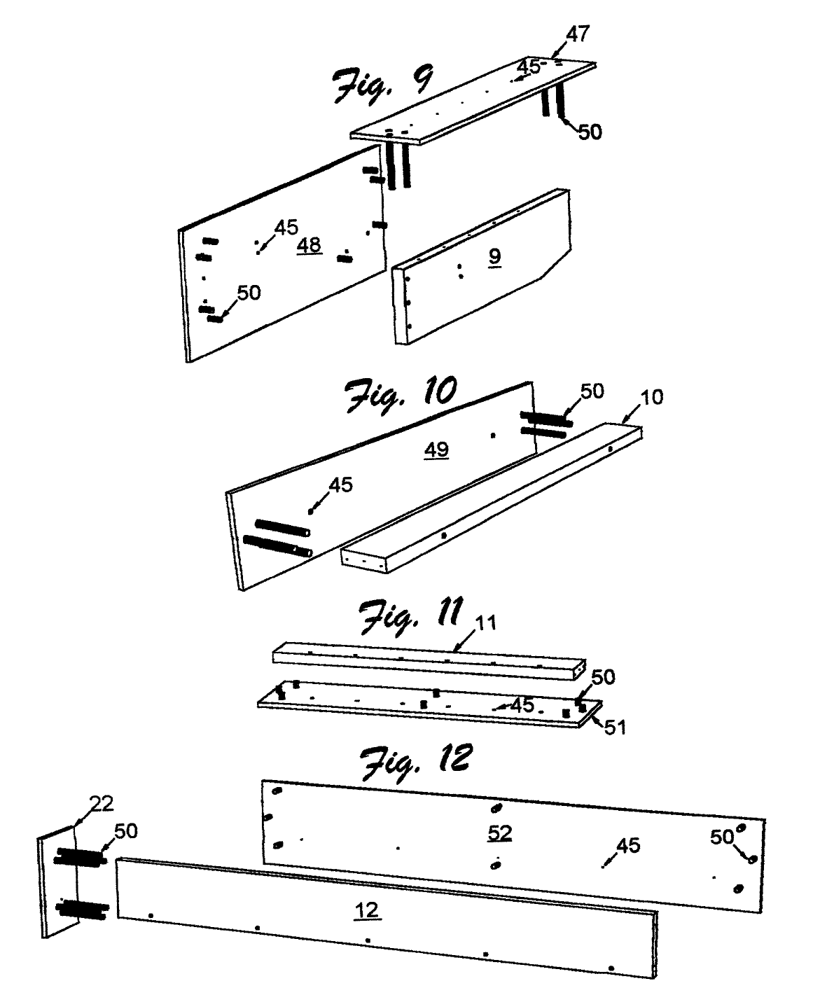

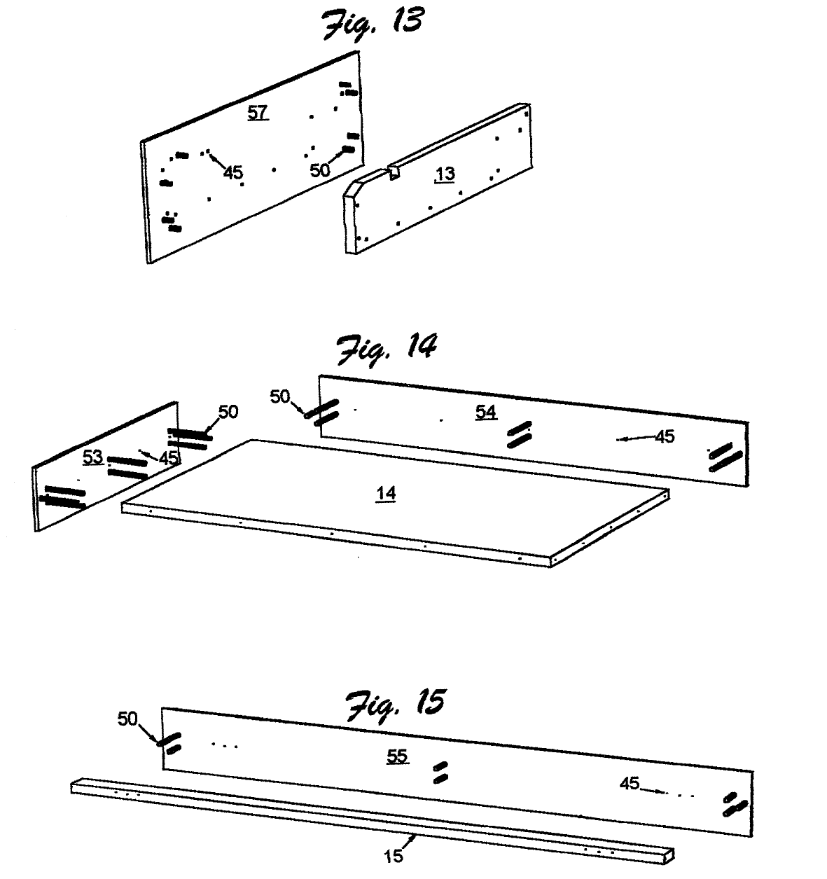

FIG. 10 is a perspective view of the Upper_Rail (10) and Upper_Rail_Jig (49). The Upper_Rail_Jig (49) provides Locator_Rods (50), and Drill_Bushings (45) for the clearance holes that receive Shackle_Pin (32) (see: FIG. 5).

FIG. 11 is a perspective view of the Lower_Rail (11) and Lower_Rail_Jig (51). The Lower_Rail_Jig (51) provides Locator_Rods (50), and Drill_Bushings (45) for clearance holes that receive the Lower_Foot_Fasteners (7) (see: FIG. 7).

FIG. 12 is a perspective view of the Upper_Side (12), End_Upper_Side_Jig (22), and Front_Upper_Side_Jig (52). The End_Upper_Side_Jig (22) provides Locator_Rods (50), and Drill_Bushings (45) (see: FIG. 22) for the pilot holes that receive Upper_Side_Fasteners (37) (see: FIG. 5) from the Upper_Foot (13) (see: FIG. 5). The Front_Upper_Side_Jig (52) provides Locator_Rods (50), and the Drill_Bushings (45) for clearance holes that receive Bottom_Fasteners (38) (see: FIG. 5).

FIG. 13 is a perspective view of Upper_Foot (13) and Upper_Foot_Jig (57). The Upper_Foot_Jig (57) provides Locator_Rods (50), and Drill_Bushings (45) for clearance holes that receive Upper_Side_Fasteners (37) (see: FIG. 5), Bottom_Fasteners (38) (see: FIG. 5), and Shackle_Fasteners (39) (see: FIG. 5). In addition, the Upper_Foot_Jig (57) provides Drill_Bushings (45) for clearance holes that mark location and angle of the Latch_Catch (36) (see: FIG. 5) and Upper_Bevel (35) (see: FIG. 5).

FIG. 14 is a perspective view of the Bottom (14), End_Bottom_Jig (53), and Front_Bottom_Jig (54). The End_Bottom_Jig (53) provides Locator_Rods (50), and Drill_Bushings (45) for pilot holes that receive Bottom_Fasteners (38) (see: FIG. 5) from Upper_Foot (13) (see: FIG. 5). The Front_Bottom_Jig (54) provides Locator_Rods (50), and Drill_Bushings (45) for the pilot holes that receive Bottom_Fasteners (38) (see: FIG. 5) from the Upper_Side (12) (see: FIG. 5).

FIG. 15 is a perspective view of the Slat (15) and Slat_Jig (55). The Slat_Jig (55) provides Locator_Rods (50), and Drill_Bushings (45) for the pilot holes that receive Hinge_Fasteners (42) (see: FIG. 2) and cooperate with the Positioner_Jigs (23) (see: FIG. 23). Only Slats (15) at the outer platform locations receive pilot holes.

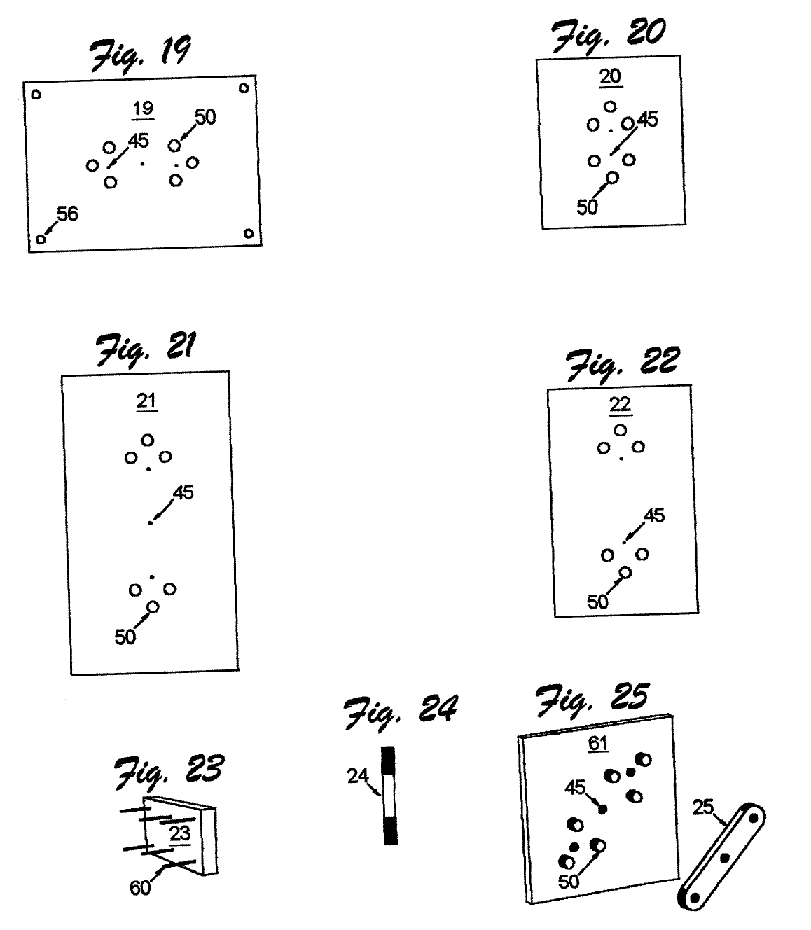

FIG. 16 is a perspective view of the Center_Rail (16) and Rail_Jig (19). The Rail_Jig (19) provides Locator_Rods (50), and Drill_Bushings (45) (see: FIG. 19) for pilot holes that receive Hinge_Fasteners (42) (see: FIG. 2) and cooperate with the Positioner_Jigs (23) (see: FIG. 23).

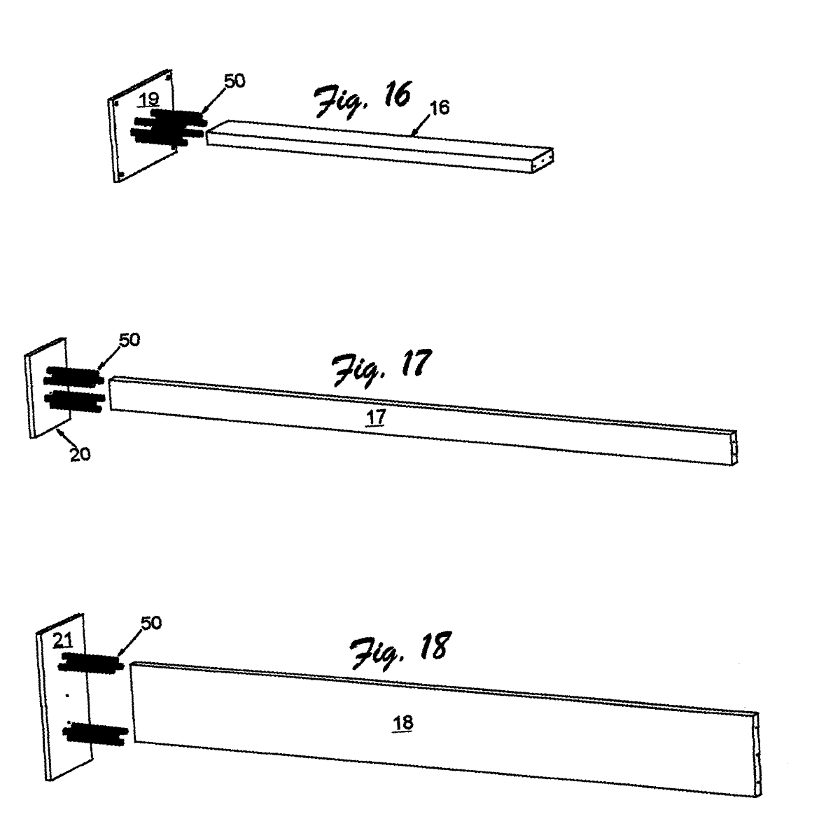

FIG. 17 is a perspective view of the Latch (17) and Latch_Jig (20). The Latch_Jig (20) provides Locator_Rods (50), and Drill_Bushings (45) (see: FIG. 20) for pilot holes that receive Latch_Fasteners (40) (see: FIG. 6) from the Lower_Foot (9) (see: FIG. 6).

FIG. 18 is a perspective view of the Lower_Side (18) and Lower_Side_Jig (21). The Lower_Side_Jig (21) provides Locator_Rods (50), and Drill_Bushings (45) (see: FIG. 21) for the pilot holes that receive Lower_Side_Fasteners (41) (see: FIG. 6) from the Lower_Foot (9) (see: FIG. 6).

FIG. 19 is a side view of the Rail_Jig (19). The Rail_Jig (19) provides Locator_Rods (50), and Drill_Bushings (45) for pilot holes that receive Hinge_Fasteners (42) (see: FIG. 2) and cooperate with the Positioner_Jigs (23) (see: FIG. 23). The Rail_Jig (19) provides Strap_Holes (56) for the attachment of elastic straps. The elastic straps facilitate attachment of two Rail_Jigs (19) onto one rail. This attachment provides both visible assurance that the two Rail_Jigs (19) polarize and that the Rail_Jigs (19) remain located during drilling activity. All rails receive pilot holes with the Rail_Jig (19).

FIG. 20 is a side view of the Latch_Jig (20). The Latch_Jig (20) provides Locator_Rods (50), and Drill_Bushings (45) for the pilot holes that receive Latch_Fasteners (40) (see: FIG. 6) from the Lower_Foot (9) (see: FIG. 6).

FIG. 21 is a side view of the Lower_Side_Jig (21). The Lower_Side_Jig (21) provides Locator_Rods (50), and Drill_Bushings (45) for pilot holes that receive Lower_Side_Fasteners (41) (see: FIG. 6) from the Lower_Foot (9) (see: FIG. 6).

FIG. 22 is a side view of the End_Upper_Side_Jig (22). The End_Upper_Side_Jig (22) provides Locator_Rods (50), and Drill_Bushings (45) for pilot holes that receive Upper_Side_Fasteners (37) (see: FIG. 5) from the Upper_Foot (13) (see: FIG. 5).

FIG. 23 is a perspective view of the Positioner_Jig (23). The Positioner_Jig (23) provides Position_Rods (60) for the pilot holes in rails and outer Slats (15) (see: FIG. 26) as the rails and slats reside within the Racked_Platform (26) (see: FIG. 26).

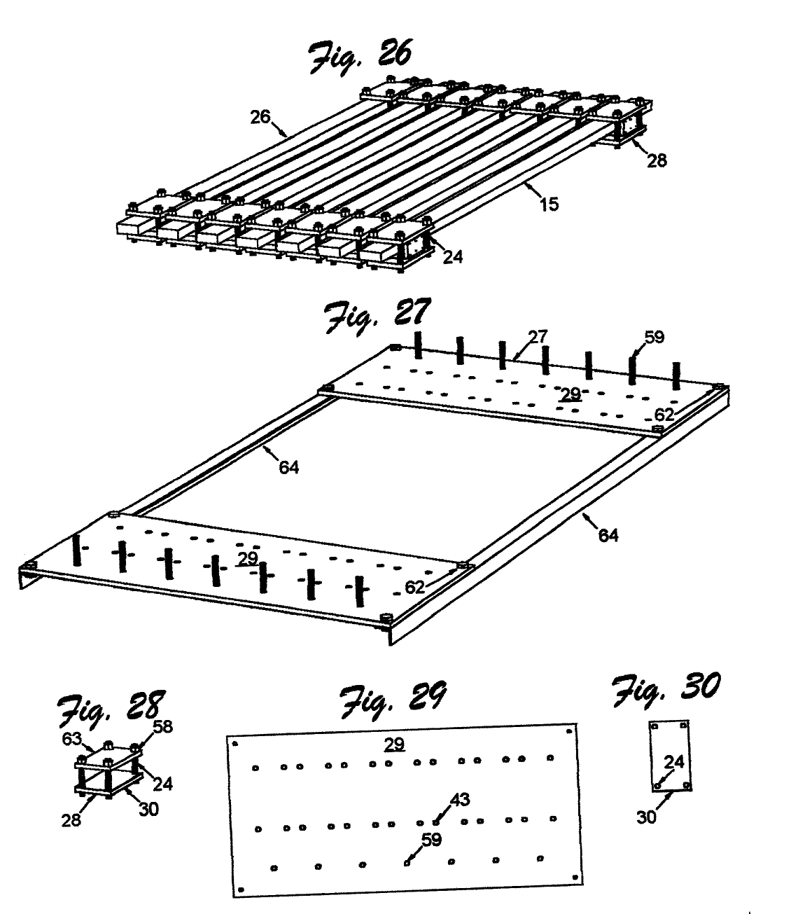

FIG. 24 is a side view of the Clamp_Rod (24). The Clamp_Rod (24) facilitates fixed attachment into the Clamp_Base (30) (see: FIG. 28) and detachable attachment to a Clamp_Fastener (58) (see: FIG. 28). Both ends of the Clamp_Rod (24) provide threading. The un-threaded center section of the Clamp_Rod (24) cooperates with Slats (15) (see: FIG. 26). The lower end of the Clamp_Rod (24) cooperates with Slat_Locator_Holes (43) (see: FIG. 29) in the Clamp_Jig (29) (see: FIG. 29) to assure spacing between Slats (15) (see: FIG. 26).

FIG. 25 is a perspective view of the Shackle (25) and Shackle_Jig (61). The Shackle_Jig (61) provides Locator_Rods (50), and Drill_Bushings (45) for clearance holes that receive the Shackle_Pin (32) (see: FIG. 5) and Shackle_Fasteners (39) (see: FIG. 5).

FIG. 26 is a perspective view of a Racked_Platform (26) formed with rails, Slats (15), and Clamps (28). The Racked_Platform (26) provides Clamp_Rods (24) that cooperate with Slat_Locator_Holes (43) (see: FIG. 29) in the Clamp_Jig (29) (see: FIG. 29).

FIG. 27 is a perspective view of a Platform_Jig (27). The Platform_Jig (27) provides Clamp_Jigs (29) connected by Jig_Bars (64) that permits beds of selected width. The Platform_Fasteners (62) bind the Clamp_Jigs (29) to the Jig_Bars (64).

FIG. 28 is a perspective view of a Clamp (28). The Clamp (28) provides a Clamp_Base (30), Clamp_Rod (24), Saddle (63), and Clamp_Fastener (58). The Clamp_Base (30) holds the Clamp_Rod (24) that provides Slat (15) (see: FIG. 26) location by cooperation with the Slat_Locator_Holes (43) (see: FIG. 29). The Clamp (28) provides Clamp_Rods (24) that permanently fix into the Clamp_Base (30). The Clamp_Rods (24) extend through the Saddle (63) and accepts a Clamp_Fastener (58) that compresses the Saddle (63) against the Slat (15) (see: FIG. 26) and rail.

FIG. 29 is a top view of the Clamp_Jig (29). The Clamp_Jig (29) provides Slat_Locator_Holes (43) and Slat Locator_Rods (59). The Slat_Locator_Holes (43) determine spacing between Slats (15) (see: FIG. 26). The Slat_Locator_Rods (59) center the Slats (15) (see: FIG. 26).

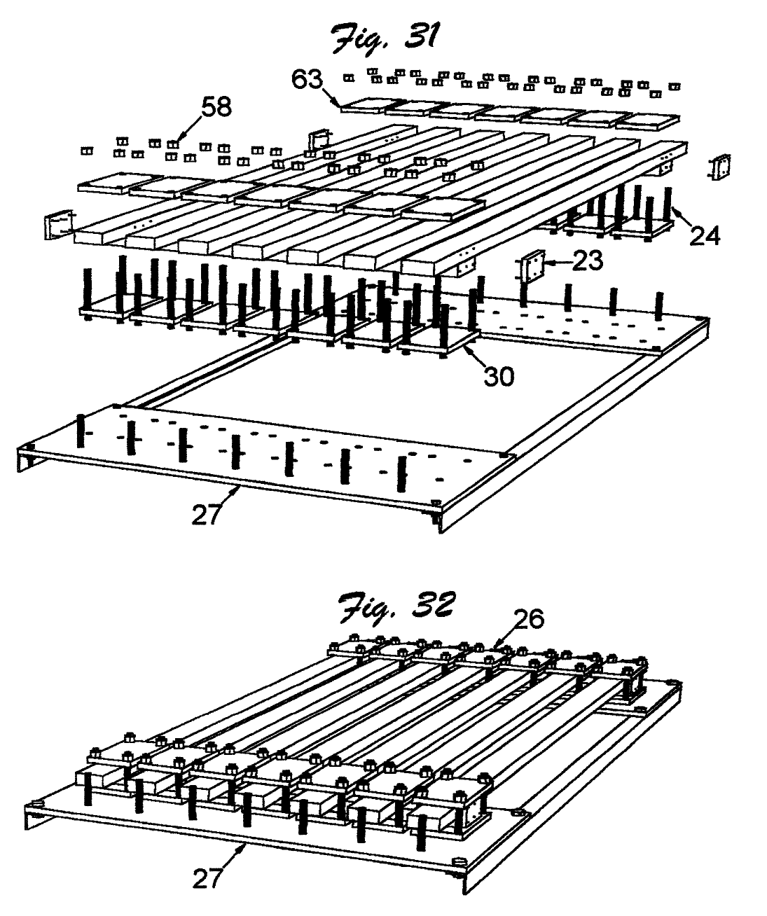

FIG. 30 is a top view of the Clamp_Base (30) The Clamp_Base (30) provides Clamp_Rods (24) that cooperate with Slats (15) (see: FIG. 26), Slat_Locator_Holes (43) (see: FIG. 29), Saddle (63) (see: FIG. 28), and Clamp_Fasteners (58) (see: FIG. 28).

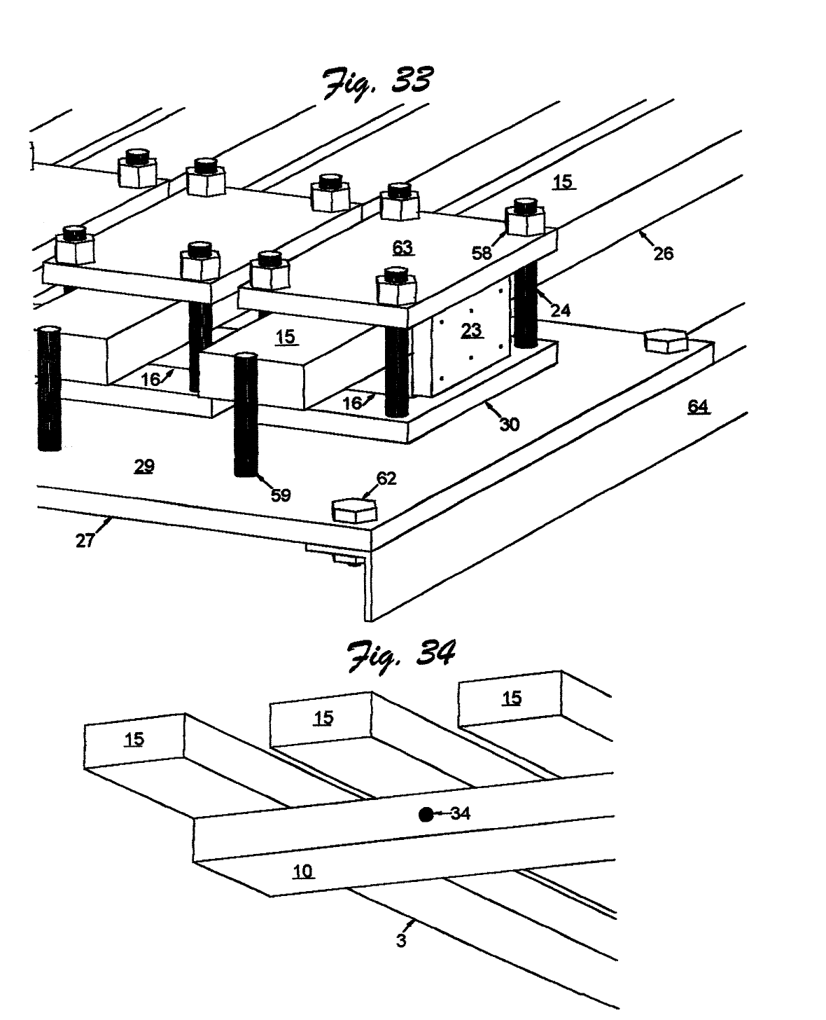

FIG. 31 is a perspective view of the exploded Platform_Jig (27) system as assembled from bottom to top. In order of assembly:

1. The Platform_Jig (27) is placed upon a level work area.

2. Clamp_Bases (30) are inserted into Clamp_Jig (29) (see: FIG. 29) in Slat_Locator_Holes (43) (see: FIG. 29).

3. A rail is placed into each set of Clamp_Bases (30). Each platform applies either a Upper_Rail (10) (see: FIG. 3), Center_Rail (16) (see: FIG. 4), or Lower_Rail (11) (see: FIG. 6).

4. Adhesive material is applied onto the locations at the intersection of rails and Slats (15) (see: FIGS. 3,4,6).

5. A Saddle (63) then Clamp_Fasteners (58) are placed upon each Clamp_Rod (24).

6. Positioner_Jigs (23) are placed into the outer Slats (15) (see: FIGS. 3,4,6) and rail intersection. Each Positioner_Jig (23) is driven into the Slats (15) (see: FIGS. 3,4,6) and rails so as to provide rail and Slat (15) (see: FIGS. 3,4,6) positioning. The rail location is a function of the Slat (15) (see: FIGS. 3,4,6) configuration.

7. The Clamp_Fasteners (58) are tightened so as to provide location control of the Racked_Platform (26) (see: FIG. 26).

8. The Clamp_Fasteners (58) are tightened so as to provide significant pressure between rails and Slats (15) (see: FIGS. 3,4.6).

9. The Racked_Platform (26) (see: FIG. 26) is removed from the Platform_Jig (27).

10. The four Positioner_Jigs (23) are removed from the Racked_Platform (26) (see: FIG. 26).

11. The Racked_Platform (26) (see: FIG. 26) is set aside to provide work area for the next Racked_Platform (26) (see: FIG. 26).

FIG. 32 is a perspective view of a Racked_Platform (26) upon the Platform_Jig (27). The Racked_Platform (26) separates from the Platform_Jig (27).

FIG. 33 is a magnified perspective view of a Racked_Platform (26) and Platform_Jig (27). This Racked_Platform (26) holds Slats (15) and Center_Rails (16) that will become a Center_Platform (4) (see: FIG. 4) with the addition of Hinge_Plates (31) (see: FIG. 4). This configuration contains: Slats (15), Center_Rails (16), Clamp_Rod (24), Clamp_Base (30), Saddle (63), Clamp_Fastener (58), Positioner_Jig (23), Clamp_Jig (29), Slat_Locator_Rod (59), Platform_Fastener(62), and Jig_Bar (64). The Positioner_Jig (23) is shorter than the height of the Center_Rail (16) plus Slat (15). The Positioner_Jig (23) removes after the Clamp_Fasteners (58) are tightened.

FIG. 34 is a magnified perspective view of a corner of the Upper_Platform (3) showing the Slats (15), Upper_Rail (10), and Pin_Hole (34) that receives a Shackle_Pin (32) (see: FIG. 5).

The following jigs provide enlarged plates that cooperate with a DRILL GUIDE:

1. Front_Lower_Foot_Jig,

2. Top_Lower_Foot_Jig,

3. Upper_Rail_Jig,

4. Lower_Rail_Jig,

5. Front_Upper_Side_Jig,

6. Upper_Foot_Jig,

7. End_Bottom_Jig,

8. Front_Bottom_Jig,

9. Slat_Jig,

10. Rail_Jig,

11. Latch_Jig,

12. Lower_Side_Jig,

13. End_Upper_Side_Jig, and

14. Shackle_Jig.

1. Chair

2. Bed

3. Upper_Platform

4. Center_Platform

5. Upper_Pedestal

6. Lower_Section

7. Lower_Foot_Fastener

8. Obverse_Hole_{—}

9. Lower_Foot

10. Upper_Rail

11. Lower_Rail

12. Upper_Side

13. Upper_Foot

14. Bottom

15. Slat

16. Center_Rail

17. Latch

18. Lower_Side

19. Rail_Jig

20. Latch_Jig

21. Lower_Side_Jig

22. End_Upper_Side_Jig

23. Positioner_Jig

24. Clamp_Rod

25. Shackle

26. Racked_Platform

27. Platform_Jig

28. Clamp

29. Clamp_Jig

30. Clamp_Base

31. Hinge_Plate

32. Shackle_Pin

33. Hinge_Pin

34. Pin_Hole

35. Upper_Bevel

36. Latch_Catch

37. Upper_Side_Fastener

38. Bottom_Fastener

39. Shackle_Fastener

40. Latch_Fastener

41. Lower_Side_Fastener

42. Hinge_Fastener

43. Slat_Locator_Hole

44. Lower_Platform

45. Drill_Bushing

46. Lower_Bevel

47. Top_Lower_Foot_Jig

48. Front_Lower_Foot_Jig

49. Upper_Rail_Jig

50. Locator_Rod

51. Lower_Rail_Jig

52. Front_Upper_Side_Jig

53. End_Bottom_Jig

54. Front_Bottom_Jig

55. Slat_Jig

56. Strap_Holes

57. Upper_Foot_Jig

58. Clamp_Fastener

59. Slat_Locator_Rod

60. Position_Rods

61. Shackle_Jig

62. Platform_Fastener

63. Saddle

64. Jig_Bar

I claim:

1. Jigs made from Locator_Rods, Drill_Bushings, and a plate with enlarged surface (or locator holes) that cooperates with a DRILL GUIDE to form:
A Front_Lower_Foot_Jig to locate Lower_Side_Fastener holes, Lower_Bevel angle-position marker holes, and one or more, Latch_Fastener hole; and
A Top_Lower_Foot_Jig to locate holes that receive Lower_Foot_Fasteners from the Lower_Rail; and
An Upper_Rail_Jig to locate Pin_Holes for Shackle_Fastener; and
A Lower_Rail_Jig to locate holes that receive Lower_Foot_Fasteners; and
A Front_Upper_Side_Jig to locate holes that receive Bottom_Fasteners; and
An End_Upper_Side_Jig to locate holes that receive Upper_Side_Fasteners from Upper_Foot; and
An Upper_Foot_Jig to locate Bottom_Fastener holes, Latch_Catch angle-position marker holes, Shackle_Fastener holes, Upper_Bevel angle-position marker holes, and Upper_Side_Fastener holes; and
An End_Bottom_Jig to locate holes in Bottom that receive Bottom_Fasteners from Upper_Foot; and
A Front_Bottom_Jig to locate holes in the Bottom that receive Bottom_Fasteners from Upper_Side; and
A Slat_Jig to locate Hinge_Fastener holes that receive Hinge_Plates or cooperate with Positioner_Jigs; and
A Rail_Jig to locate Hinge_Fastener holes that receive Hinge_Plates or cooperate with a Positioner_Jig, and provide retainer strap holes that cooperate to bind Rail_Jig to rail; and
A Latch_Jig to locate, one or more, holes that receive, one or more, Latch_Fasteners from Lower_Foot; and
A Lower_Side_Jig to locate holes that receive Lower_Side_Fasteners from Lower_Foot; and
A Shackle_Jig to locate holes that receive a Shackle_Pin from Upper_Rail, and Shackle_Fasteners from Upper_Foot.

2. A Clamp_Jig formed from a plate, Locator_Rods, and Drill_Bushings (or locator holes) to cooperate with Jig_Bars, Slats, and Clamps.

3. A Positioner_Jig formed from a plate and Position_Rods to locate rail Hinge_Fastener holes in cooperation with Slat Hinge_Fastener holes.

4. A Platform_Jig formed with Clamp_Jigs, Jig_Bars, and Platform_Fasteners to locate Slats within Clamps.

5. A Clamp that compresses a rail and Slat in cooperation with Platform_Jig and Positioner_Jig.

6. The above jigs and Clamp jointly and severally.
